(19) United States
(12) Patent Application Publication
(10) Pub. No.: US 2010/0042393 A1
(43) Pub. Date: Feb. 18, 2010

(54) METHOD AND SYSTEM FOR SIMULATING THE OPERATION OF AN INTERNAL COMBUSTION ENGINE

(76) Inventors: Thomas Kruse, Stuttgart (DE); Ulrich Schulmeister, Tamm (DE)

Correspondence Address: KENYON & KENYON LLP, ONE BROADWAY, NEW YORK, NY, 10004, US

(21) Appl. No.: 12/448,036

(22) PCT Filed: Dec. 20, 2007
(86) PCT No.: PCT/EP2007/064397

§ 371 Date: Oct. 13, 2009

(30) Foreign Application Priority Data
Dec. 29, 2006 (DE) 102006061936.6

(51) Int. Cl. G06G 7/66

(52) U.S. Cl. 703/7; 703/6

(57) ABSTRACT

In a method for simulating the operation of an internal combustion engine which has an associated control unit having a plurality of control parameters influencing the operation of the internal combustion engine, a model is used for the simulation. In the model, in addition to the control parameters of the control unit, component parameters that characterize an operation of at least one additional component associated with the internal combustion engine are also taken into account.

### BACKGROUND OF THE INVENTION

1. Field of the Invention

The present invention relates to a system and a method for simulating the operation of an internal combustion engine which has a control unit having a plurality of control parameters influencing the operation of the internal combustion engine.

2. Description of Related Art

Such methods and systems are known and are usually used in the context of a development process in order to optimize an internal combustion engine with respect to its operating behavior. As soon as new components such as e.g. a new fuel system or the like are to be combined with the internal combustion engine, the control parameters must be adapted in such a way that the desired operating characteristics of the internal combustion engine are also achieved in interaction with the new components. In addition to the isolated simulation of the internal combustion engine that takes into account only the control parameters of the control unit, the control parameters are therefore subsequently adapted by an application process, in which the control parameters are usually adapted manually and changes in the operating characteristics effected thereby are recorded by measuring technology on a test setup or prototype.

The disadvantage in the known methods is the great expenditure and use of resources associated with the manual application and performance of measurements as well as the requirement of performing such steps for each additional new component.

### BRIEF SUMMARY OF THE INVENTION

Accordingly, it is an objective of the present invention to improve a method and system of the type mentioned at the outset in such a way that the expenditure and use of resources known from conventional methods is reduced and in particular the requirement of manual adaptations and the use of test setups is largely eliminated.

This objective is achieved in that a model is used for the simulation that in addition to the control parameters of the control unit also takes in to account component parameters characterizing an operation of at least one additional component associated with the internal combustion engine. Because of the inventive simultaneous consideration of the control parameters of the control unit, which may be an engine control unit for example, and the component parameters characterizing the components, the interaction of the internal combustion engine with new components such as e.g. injectors or the like may be advantageously simulated in a comprehensive manner. The model of the present invention allows for an optimization of the internal combustion engine including the associated components such that in particular the conventional two-stage process of the isolated simulation of the internal combustion engine itself and a subsequent adaptation of the control parameters to the respective new components and the associated resource expenditure may be avoided. In a particularly advantageous manner, the model according to the present invention also allows for dependencies between the control parameters and the component parameters to be taken into account and thus allows for a precise and at the same time efficient optimization of the functional unit formed by the internal combustion engine and its associated components.

If the component parameters characterize the operation of a fuel system associated with the internal combustion engine, in particular an injector, and/or the operation of an air system associated with the internal combustion engine, then the simulation of the internal combustion engine according to the present invention may occur advantageously, among other things, with the objective of an optimization with respect to the emission characteristics of the internal combustion engine. The component parameters may characterize additional systems of the internal combustion engine such as e.g. sensor units, in particular temperature sensors etc., or even a transmission control system or the like.

In another example embodiment of the method according to the present invention, the control parameters and/or component parameters may also be at least in part software parameters, which are designed in particular as applicable parameters of a control unit or the computing unit controlling the component, and which are stored in a memory associated with the computing unit following a successful simulation. In contrast to the conventional manual application, which comprises a time-consuming successive modification of multiple parameters, using the model according to the present invention, the parameters may be ascertained once and subsequently stored, in particular without subsequently additional modifications of the parameters being required.

Particularly advantageously, the control parameters and/or in particular the component parameters represent at least in part physical, in particular electrical and/or mechanical properties of the control unit or of the components such that instead of numerous test setups with components having various parameters of this kind, the desired configuration is primarily obtained by the simulation and test setups mainly have to be provided only by way of random sample for verifying individual parameter configurations. In addition, new components, which have similar physical properties or even a similar geometry as known components, or their component parameters may possibly be derived from parameters of the known components already used in the model according to the present invention such that it is unnecessary to ascertain the component parameters of the new component by way of a test setup or a series of measurements.

According to another advantageous example embodiment of the present invention, a possibility of efficiently optimizing the internal combustion engine including its associated components is provided by the fact that a target function quantifying a desired operating behavior of the internal combustion engine is formed and the operating behavior of the internal combustion engine is optimized as a function of the target function by changing the control parameters and/or the component parameters.

According to the present invention, the model of the present invention may be formed and/or supplemented in that dependencies between the control parameters and/or the component parameters are ascertained, in particular on the basis of a test setup, or already known dependencies are integrated into the model.

### BRIEF DESCRIPTION OF SEVERAL VIEWS OF THE DRAWING

FIG. 1a shows a schematic illustration of an internal combustion engine controlled by a control unit according to the present invention.

FIG. 1b shows a simplified block diagram of a system according to the present invention.

FIG. 2 shows a flow chart of an example embodiment of the method according to the present invention.

### DETAILED DESCRIPTION OF THE INVENTION

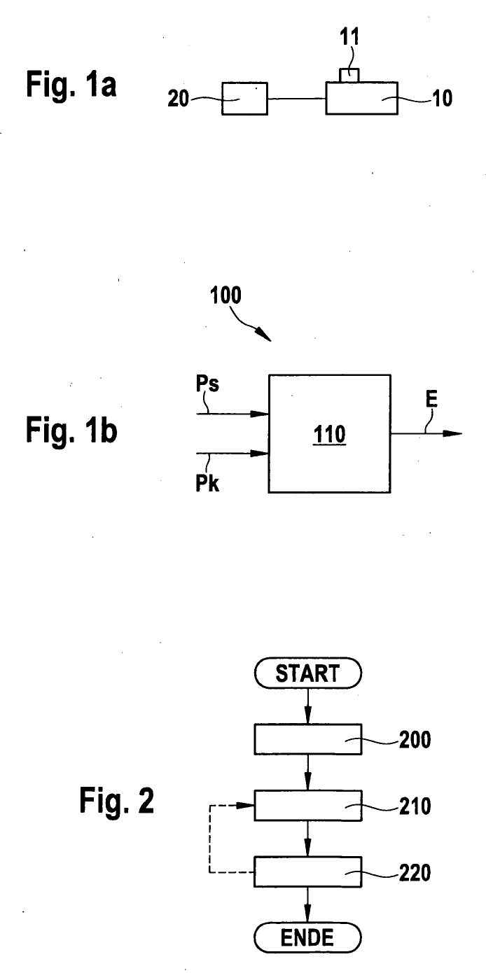

FIG. 1a schematically shows an internal combustion engine 10 of a motor vehicle, to which a control unit 20 developed for example as an engine control unit is assigned. Control unit 20 controls and/or regulates the operation of internal combustion engine 10 as a function of a multiplicity of control parameters, which in the present case are stored in a nonvolatile memory (not shown) of control unit 20 and which may be adapted for example in the context of an application process.

The control parameters influence the operating behavior of internal combustion engine 10 and may affect e.g. in particular also the emission behavior of internal combustion engine 10.

For simulating the internal combustion engine 10 shown in FIG. 1a, system 100 of the present invention represented in FIG. 1b in the form of a block diagram is provided, which may be implemented for example with the aid of a personal computer and a software programmed to carry out the method of the present invention.

System 100 has a model 110, which is used in accordance with the present invention for simulating the operating behavior of internal combustion engine 10. Model 110 is supplied with control parameters of control unit 20, in the present case symbolized by arrow Ps, which makes it possible to take into account corresponding parameter values for simulating the operating behavior. This allows for the operating behavior of internal combustion engine 10 to be investigated under the influence of various parameter values or a combination of various parameters without requiring a corresponding test setup.

Additionally, according to the present invention, model 110 is also supplied with component parameters Pk, which are likewise symbolized by an arrow and which characterize an operation of at least one additional component 11 (cf. FIG. 1a) associated with internal combustion engine 10. Component 11 may be a fuel system of internal combustion engine 10, for example, or merely a certain injector. Generally, component 11 may represent any system interacting with internal combustion engine 10 that influences the operating behavior of internal combustion engine 10 or whose own operating behavior may be influenced by control parameters Ps that are used by control unit 20.

Taking into account component parameters Pk together with control parameters Ps in the same model 110 in accordance with the present invention advantageously allows for a precise simulation of the operating behavior of internal combustion engine 10, in particular also the interaction between internal combustion engine 10 and component 11.

Compared to conventional methods, in which parameters Ps, Pk are respectively optimized separately for internal combustion engine 10 and component 11 and are subsequently adapted in a combination of components 10, 11 e.g. by using test setups, the modeling according to the present invention using model 110, which simultaneously uses both parameter groups Ps, Pk, also allows for dependencies of individual parameters belonging to different parameter groups Ps, Pk to be taken into account already in the simulation phase. When applying the method according to the present invention, this advantageously makes it possible to reduce the number of test setups and control measurements, which allows for a faster development cycle and increases efficiency.

In addition, once correlations have been ascertained and integrated into model 110 according to the present invention, they may be used for subsequent development or simulation processes as well.

As described above, control parameters Ps preferably take the form of software parameters, but may also represent physical, in particular geometrical variables or other properties of control unit 20 that affect the operating behavior of internal combustion engine 10.

The component parameters Pk may represent in particular physical, e.g. electrical and/or mechanical or geometrical properties of component 11. For example, component parameters Pk associated with a component 11 in the form of a fuel injector may characterize a jet angle or a number of jets, flow properties, and e.g. moments of inertia of movable elements and the like. Likewise, component parameters Pk may represent parameters relating to the control of the fuel injector such as e.g. a differential resistance of an input stage or driver stage or the temperature dependence of the electrical parameters of the fuel injector.

In the case of such components associated with internal combustion engine 10, which are separately controlled by a computing unit such as e.g. a microcontroller, the component parameters Pk may also include software parameters of this computing unit so as to allow for a complete characterization of the relevant operating behavior of component 11.

In a first step 200 of the simulation method of the present invention shown in FIG. 2, a target function quantifying a desired operating behavior of internal combustion engine 10 (FIG. 1a) is formed, which takes on corresponding values as a function of the parameters Ps, Pk. The target function may be a function, for example, which describes the emission behavior of internal combustion engine 10 as a function of parameters Ps, Pk. A resulting value E of the target function ascertained through model 110 (FIG. 1b) of the present invention by way of simulation is evaluated in a second method step 210 of the present invention.

Evaluation 210 is followed in method step 220 by a modification of selected parameters Ps, Pk of setup 10, 11, whereupon steps 210, 220 are possibly repeated until a specifiable termination criterion is fulfilled. The termination criterion may indicate for example that a specifiable resulting value has been reached. Modification 220 of parameters Ps, Pk may be performed for example by using optimization algorithms known to one skilled in the art, in particular also as a function of a difference of the current resulting value E from a targeted resulting value.

The method of the present invention described above makes it possible to adapt new components 11 such as e.g. fuel injectors, entire fuel or air systems, sensor devices or other components efficiently and precisely to an internal combustion engine 10 or to other components associated with internal combustion engine 10. In particular, the combined consideration of parameters Ps, Pk in model 110 (FIG. 1b) according to the present invention allows for resource-intensive measurement series and test setups to be largely omitted.

Only for the initial formation of model 110 or for supplementation by the operating behavior of novel components 11 it is indispensable to ascertain dependencies between control parameters Ps and/or component parameters Pk on the basis of a test setup, unless the relevant correlations may be transferred from other already existing models to model 110 and integrated into it.

1-7. (canceled)

8. A method for simulating the operation of an internal combustion engine having a control unit providing a plurality of control parameters influencing the operation of the internal combustion engine, comprising:
performing a simulation of the operation of the internal combustion engine using a model, wherein the model takes into account the control parameters of the control unit and component parameters characterizing an operation of at least one additional component associated with the internal combustion engine.

9. The method as recited in claim 8, wherein the component parameters characterize the operation of at least one of a fuel system associated with the internal combustion engine and an air system associated with the internal combustion engine.

10. The method as recited in claim 8, wherein the control parameters are software parameters of a computing unit controlling the control unit and the component parameters are software parameters of a computing unit controlling the at least one additional component.

11. The method as recited in claim 8, wherein the control parameters represent at least one of electrical and mechanical properties of the control unit, and wherein the component parameters represent at least one of electrical and mechanical properties of the at least one additional component.

12. The method as recited in claim 9, wherein a target function quantifying a desired operating behavior of the internal combustion engine is formed, and the operating behavior of the internal combustion engine is optimized as a function of the target function by changing at least one of the control parameters and the component parameters.

13. The method as recited in claim 9, wherein the model is formed at least in part by ascertained dependencies between the control parameters and the component parameters.

14. A system for simulating the operation of an internal combustion engine, comprising:
a computing unit programmed to perform a simulation of the operation of the internal combustion engine using a model, wherein the model takes into account control parameters of a control unit influencing the operation of the internal combustion engine, and wherein the model further takes into account component parameters characterizing an operation of at least one of a fuel system associated with the internal combustion engine and an air system associated with the internal combustion engine.
